(19) United States
(12) Patent Application Publication
(10) Pub. No.: US 2009/0169668 A1
(43) Pub. Date: Jul. 2, 2009

(54) TRANSVERSE STRETCHING DEVICE

(75) Inventors: Kari Kirjavainen, Tampere (FI); Teuvo Arpiainen, Nokia (FI)

Correspondence Address: BROOKS KUSHMAN P.C., 1000 TOWN CENTER, TWENTY-SECOND FLOOR, SOUTHFIELD, MI, 48075, US

(73) Assignee: CONENOR OY, Tampere (FI)

(21) Appl. No.: 12/294,576

(22) PCT Filed: Mar. 27, 2007
(86) PCT No.: PCT/FI07/50166

§ 371 Date: Sep. 25, 2008

(30) Foreign Application Priority Data
Mar. 28, 2006 (FI) 20065201

(51) Int. Cl. B29C 67/00

(52) U.S. Cl. 425/383

(57) ABSTRACT

A transverse stretching device comprises two stretching wheels and endless bands arranged against them and revolving around band guide rolls so that a plastic film to be stretched is arranged at its both edges between a stretching wheel and a band. The stretching wheels and the bands are arranged in such a way that in the direction of travel of the plastic film they are further apart from each other at the end than in the beginning, whereby the transverse stretching device stretches the plastic film in the transverse direction. The stretching wheels are rims open in the center and the device includes heating means arranged through the rims at least at some angle between the stretching wheels.

### BACKGROUND OF THE INVENTION

The invention relates to a transverse stretching device comprising two stretching wheels and endless bands arranged against them and revolving around band guide rolls so that both edges of a plastic film to be stretched are arranged between a stretching wheel and a band, the stretching wheels and the bands being arranged in such a way that in the direction of travel of the plastic film they are further apart from each other at the end than in the beginning, whereby the transverse stretching device stretches the plastic film in the transverse direction; means for adjusting the angle between the stretching wheels; and a heating device for heating the plastic film while it is being stretched.

A plastic film is typically manufactured by extruding first a plastic film preform, which is then stretched to produce a film of a desired thickness. The stretching may be carried out in the direction of travel of the plastic film preform, i.e. in the machine direction, by means of a machine-direction stretching device. It is also possible to stretch the plastic film preform in a transverse direction in relation to the direction of travel of the preform by means of a transverse stretching device. The transverse stretching device typically grips the edges of the plastic film preform and stretches them away from each other, thus allowing the plastic film preform to be made wider. During the stretching the plastic film typically orientates at the same time to the direction of the stretching and therefore the stretching device may also be referred to as an orientating device.

Publication EP 0,449,548 discloses a transverse stretching device. The device in question has two stretching wheels provided with a central shaft and endless bands arranged against the wheels and revolving around guide rolls. In this device both edges of a plastic film preform are arranged between a wheel and a band, the wheels and the bands being arranged in such a way that in the direction of travel of the film preform they are further apart from each other at the end than in the beginning, the stretching device thus stretching the plastic film in the transverse direction. Publication WO 99/51,419 discloses a similar stretching device. The WO publication further discloses a solution in which the film is heated by means of a heating device arranged between the stretching wheels. The publication also teaches that the stretching device is arranged into a casing and that the film is heated with a radiant heater located in the casing. A heating device placed between the wheels is inconvenient in view of the adjustment of the angle between the wheels. Moreover, the thermal efficiency of radiant heaters placed inside casings is relatively deficient.

Publication EP 0,672,526 discloses a transverse stretching device having two rims supported in place by means of inner support rolls. Outside the rims there are provided endless bands that clamp the film preform to be stretched against the outer surface of the rims. The rims and the bands are arranged so that in the direction of travel of the plastic film they are further apart from each other at the end than in the beginning. Also in this case the heating of the plastic film during the transverse stretching thereof is extremely difficult, and the publication does not even disclose any instructions for such heating.

### SUMMARY OF THE INVENTION

It is an object of the invention to provide a novel transverse stretching device.

The device of the invention is characterized in that the stretching wheels are rims open in the centre and that at least at some angle between the stretching wheels there is at least one heating device arranged through the rims.

The basic idea of the invention is that the transverse stretching device comprises two stretching wheels and endless bands arranged against them and revolving around band guide rolls so that both edges of a plastic film or a plastic film preform are arranged between a stretching wheel and a band. The stretching wheels and the bands are arranged in such a way that in the direction of travel of the plastic film they are further apart from each other at the end than they were at the beginning, whereby the transverse stretching device stretches the plastic film in transverse direction. The stretching wheels are rims open in the centre, and the device is provided with heating means arranged through the rims at least at some angle between the wheels. This allows the plastic film to be effectively heated during the transverse stretching thereof, and yet the structure of the transverse stretching device is reasonably simple and its manufacturing costs are affordable.

The idea of one embodiment is that the rims are supported in place by support means such that the inner circumference of the rims has an area covering an angle of at least 120° that is free of support means. This area allows the interior heating means to be placed extremely close to the film to be stretched.

The idea of a second embodiment is that at least one support means of a rim is arranged outside the rim. This provides a simple means for arranging an area free of support means inside the rim and yet enables an excellent rim support to be achieved.

The idea of a third embodiment is that the heating means operate by circulating air through a blow conduit onto the film to be stretched and then through a suction conduit back to the heating means. This allows an even airflow and a uniform temperature to be provided on the entire width of the film without heat loss, the good utilization ratio of the thermal energy to be transferred to the film allowing the speed and yield of the line to be increased.

### BRIEF DISCLOSURE OF THE FIGURES

The invention will be explained in greater detail with reference to the accompanying drawings, in which

FIG. 1 is a schematic side view of a transverse stretching device;

FIG. 2 is a perspective view of the device of FIG. 1 seen diagonally from above;

FIG. 3 corresponds to the view of FIG. 2, except that the device is arranged to stretch the film wider than in FIG. 2;

FIG. 4 is a schematic view of some parts of the transverse stretching device; and

FIG. 5 is a schematic cross-sectional end view of a heating device.

For the sake of clarity some embodiments of the invention are simplified in the drawings. Like parts are referred to with like reference numerals.

### DETAILED DISCLOSURE OF SOME EMBODIMENTS OF THE INVENTION

FIG. 1 shows a transverse stretching device 1. A film preform or a film 2 is first extruded in a film manufacturing line. The film 2 is a plastic film typically made of polyethylene PE or polypropylene PP or some other suitable plastic material. After the extrusion the film 2 is stretched to its final dimensions. In addition to the transverse stretching device 1 shown in FIG. 1 the film may be stretched also in its direction of travel, i.e. in a machine-direction stretching device. Further, the plastic film manufacturing line may include cooling and annealing equipment and a roll onto which the film is rolled, and other similar structures. However, such structures, the extruder and other stretching devices are not shown in the enclosed drawings, because their construction and operation are obvious to a skilled person.

The film 2 travels through the manufacturing line guided by auxiliary rolls 3. The transverse stretching device 1 stretches the plastic film 2 in the cross direction, i.e. transversally in relation to the direction of travel of the plastic film 2. The plastic film 2 travels in the direction of arrow A.

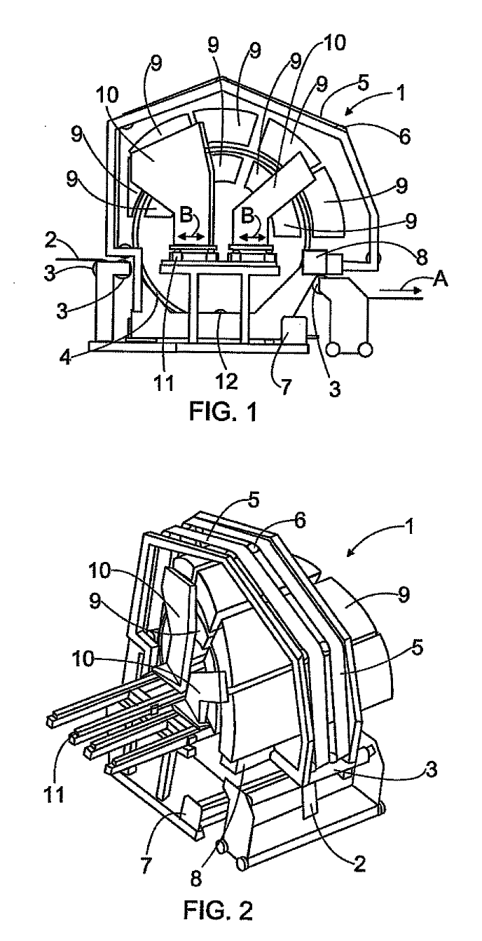

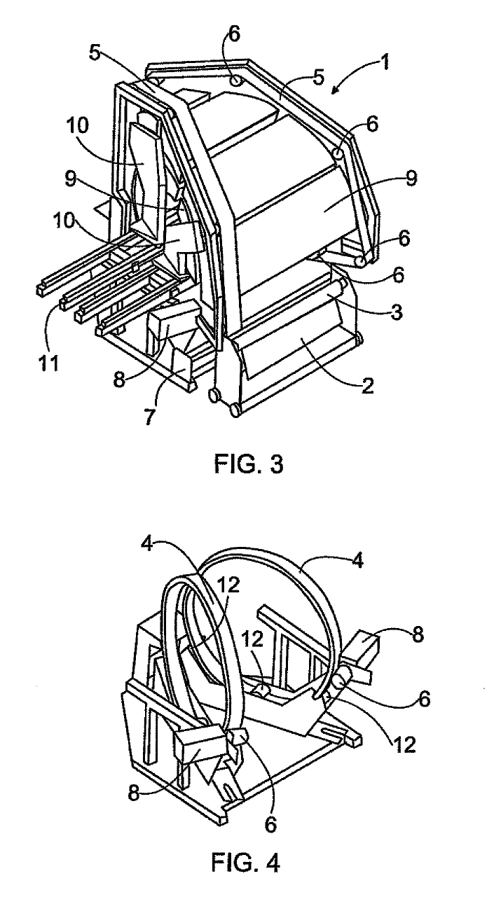

The transverse stretching device 1 has two stretching wheels 4, with an endless band 5 arranged against both of them. The travel of the endless band 5 is guided by means of band guide rolls 6. The band guide rolls 6 are clearly visible in FIG. 2, for example, and particularly in FIG. 3.

The edges of the plastic film 2 are arranged between a stretching wheel and a band 5. Hence the edges of the plastic film 2 set evenly and the band 5 strongly clamping them between the band 5 and the stretching wheel 4 substantially on the entire distance of the transverse stretching device 1, whereby the film is not subjected to any concentrated pressure or tensile stress. The plastic film 2 thus stretches in width direction without being torn. The stretching wheels 4 and, correspondingly, the bands 5 are arranged in such a way that when the plastic film 2 is stretched in its direction of travel, they are further apart from each other at the end than in the beginning, as shown in FIG. 3. The transverse stretching device 1 thus stretches and at the same time orientates the plastic film 2 in the transverse direction thereof.

The transverse stretching device 1 includes a spreading mechanism 7 allowing the deviation from the machine direction of the angle between the stretching wheels 4 and the bands 5 to be adjusted so as to provide transverse stretching of a desired extent. The angle may be adjusted within the extreme positions shown in FIGS. 2 and 3. In connection with the orientation wheels 4 and the bands 5 there is a support structure, which is pivotally arranged at the forward end of the stretching device 1 and thus allows the extent of the stretching to be adjusted.

One or more of the band guide rolls 6 may be arranged to be rotatable by a rotating means 8. The rotating means 8 may be an electric motor, for example. Since the bands 5 are firmly pressed against the stretching wheels 4, rotating devices are not necessarily needed in connection with the stretching wheels 4, but they may rotate freely. Further, the rotating device 8 may be arranged to rotate the stretching wheel 4, in which case no rotating means are necessarily needed to rotate any of band guide rolls 6, but they may be freely rotated by the stretching wheels 4 and the band 5.

During transverse stretching the plastic film 2 is heated by means of heating devices 9. As shown in FIG. 4, the stretching wheels 4 are rims open in the centre. There are heating devices 9 arranged through the rims 4 to heat the plastic film 2 from the inside. There are heating devices 9 also outside the rims to heat the plastic film 2 from above. Since the stretching wheels 4 are open rims, the changing of the angle between them, i.e. the adjustment of the stretching, is in no way dependent on the heating device 9. Consequently, the plastic film 2 can be effectively heated during stretching and yet the structure of the stretching device is not particularly complicated.

The heating devices 9 are supported to moving devices 10 which enable the heating devices 9 to be moved back and forth as shown by arrows B in FIG. 1. The moving devices 10 are to be used for moving the heating devices 9 when the spreading mechanism 7 is used for changing the stretching angle of the stretching wheels 4 and the bands 5. For example, when the angle is changed from the position of FIG. 2 to the position of FIG. 3, the heating devices 9 on the right in FIG. 1 are to be moved to the left when seen in FIG. 1 to enable the heating devices 9 to be kept at an optimal distance from the plastic film 2. It is also possible to provide a plural number of moving devices 10 for moving the heating devices 9, but in the embodiment of the accompanying figures the heating devices 9 are divided into two different groups and therefore two pairs of moving devices are provided in connection with the heating device 1.

The heating device 1 is further provided with rails 11 along which the heating devices 9 can be removed for servicing, for example.

The stretching wheels 4 are supported to the support structure by means of support rolls 12 or other similar support means. The support rolls 12, or the like, are arranged such that a portion as large as possible of the inner circumference of the stretching wheels 4, i.e. the rims, is free of support means. This area without support means preferably covers a distance of at least 120°. Particularly preferably the area without support means is more than half of the inner circumference of the stretching wheel 4. This allows the heating means 9 to be arranged inside the stretching means 4 as close to their outer periphery as possible, i.e. as close as possible to the film to be stretched. This enables the heating to be efficiently focused to the film 2.

The support rolls 4 are preferably arranged in such a way that at least one of them is arranged outside the stretching wheel 4, i.e. the rim. This way it is simple to provide an area free of support means inside the rim and yet the rim is extremely well supported. Preferably at least two support rolls 2 are arranged outside the rim. As shown in FIG. 4, a very strong support is obtained by means of three support rolls, two of which are arranged outside and one inside the rim.

In addition, the rims are laterally supported with bearings. A good lateral support is achieved by means of lateral bearings arranged at three different locations, for example.

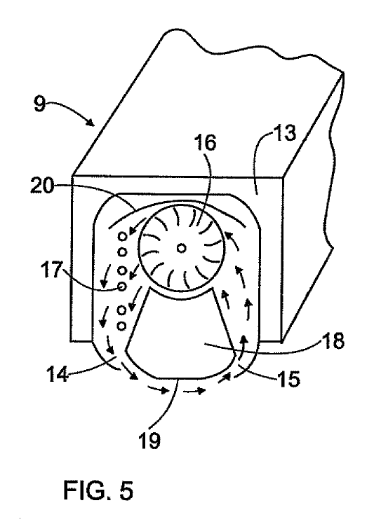

FIG. 5 illustrates the structure of a preferred heating device 9. The body of the heating device 9 is indicated with reference numeral 13. The heating device 9 is used to circulate hot air from an inlet conduit 14 so that it flows on the surface of the plastic film 2 as indicated by the arrows in FIG. 5. From the surface of the plastic film 2 the air is directed back to the heating device 9 through a suction conduit 15. The flow of air is generated by means of a transverse blower unit 16 provided with wings longitudinal with respect to the heating device 14. The air is heated with heating resistors 17.

The heating device of FIG. 5 allows an even airflow and a uniform temperature to be provided on the entire width of the plastic film 2. In addition, heat is not lost, and the line speed may be kept at the maximum.

The heating device further comprises a flow guide frame 18, whose outer surface 19 is arranged close to the plastic film 2. The outer surface 19 is preferably black, which provides the most efficient radiation towards the plastic film 2.

The heating device 9 may also include other flow guides 20. The heating resistors 17 may also be distributed as a zone in the width direction of the plastic film 2, whereby the heat profile generated by the heating device 9 can be adjusted. The heating devices 9 may also be provided with shielding plates, whereby in the case of FIG. 2, for example, those parts of the heating devices 9 that are not at the plastic film 2 may be covered. This enables heat loss to be further reduced.

In some cases the features disclosed in this application may be applied as such, independently of the other features. On the other hand, the features presented in this application may be combined, when necessary, to provide different combinations.

The drawings and the related specification are only intended to illustrate the idea of the invention. The details of the invention may vary within the scope of the claims. The disclosed stretching device is compact and its manufacturing costs are affordable. In addition, its particularly well suited as an additional device for existing lines providing longitudinal orientation, for example, thereby allowing the properties of film products manufactured on these lines to be improved and also totally new products to be produced. Further, the device is suitable for mounting to existing extrusion lines and also for use “offline”, meaning that a film produced on an extrusion line and orientated in the longitudinal direction, for example, may be rolled onto a roll and then later driven through an exclusively transverse stretching device for orientation in a separate phase. Due to its compact structure the device is also easily movable from one manufacturing line to another, the device thus offering excellent applicability in comparison with commonly used fixedly mounted stretching devices known as tenter frame stretching devices, for example.

1. A transverse stretching device comprising:
two stretching wheels and endless bands arranged against them and revolving around band guide rolls so that both edges of a plastic film to be stretched are arranged between a stretching wheel and a band, the stretching wheels and the bands being arranged in such a way that in the direction of travel of the plastic film they are further apart from each other at the end than in the beginning, whereby the transverse stretching device stretches the plastic film in the transverse direction;
means for adjusting the angle between the stretching wheels ; and
a heating device for heating the plastic film while it is being stretched, wherein
the stretching wheels are rims open in the center and that at least at some angle between the stretching wheels there is at least one heating device arranged through the rims.

2. A stretching device according to claim 1, wherein
the rims are supported in place by support means in such a way that the inner circumference of the rims has an area covering an angle of at least 120° that is free of support means.

3. A stretching device according to claim 2, wherein
the area free of support means covers more than half of the inner circumference of the rim.

4. A stretching device according to claim 2, wherein each rim is provided with at least three support means, of which at least one is arranged outside the rim.

5. A stretching device according to claim 4, wherein
at least two support means of each rim are arranged outside the rim and between them there is at least one support means arranged inside the rim.

6. A stretching device according to claim 1, wherein
the heating device includes
an inlet conduit arranged to direct heated air onto the plastic film;
a suction conduit arranged to return the air from the plastic film back to the heating device;
a blower unit for generating an airflow; and
heating means for heating air.

7. A stretching device according to claim 6, wherein
the heating means are distributed in zones in the width direction of the plastic film to adjust the heat profile generated by the heating device.

8. A stretching device according to claim 6, wherein
the heating device includes a flow guide frame whose outer surface is arranged close to the plastic film, the outer surface being black.
